(19) United States
(12) Patent Application Publication
(10) Pub. No.: US 2003/0148663 A1
(43) Pub. Date: Aug. 7, 2003

(54) MULTIPURPOSE ADAPTOR WITH A UNIVERSAL SERIAL BUS CONNECTOR

(76) Inventor: Liao Sheng Hsin, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/062,762

(22) Filed: Feb. 5, 2002

(51) Int. Cl. H01R 25/00

(52) U.S. Cl. 439/638

(57) ABSTRACT

This invention provides a multipurpose USB connector for charging batteries of various portable electric apparatuses. A connector includes a main body, a circuit unit, an input connector, an output port, an output line, and a battery connecting base. The main body is a hollow casing consisting of a first half and a second half. The output connector, output port, and battery connecting base are electrically connected with the circuit board. The input connector is a universal serial bus (USB) connector.

### BACKGROUND OF THE INVENTION

1. Field of the Invention

The present invention relates to a multipurpose universal serial bus (USB) connector. More particularly, the present invention relates to a portable USB connector for charging batteries. In use, the portable USB connector may be electrically connected to a notebook or a dry battery.

2. Description of the Prior Art

As the information technology has been developed, there are many kinds of portable electric apparatuses such as notebooks, cell phones, and personal digital assistant (PDA) are widely used by people in this information age. In use, these portable apparatuses are powered by chargeable batteries such as lithium battery, NiMH battery, Ni-Cd battery. Typically, when the electric power of the batteries is low, these chargeable batteries are charged by using a charger to recover their power. However, the conventional chargers are not user friendly and big in size. Also, one specific charger is often suitable only for one of these kinds of commercial batteries.

Consequently, there is a strong need to provide a multipurpose USB connector for charging batteries of various portable electric apparatuses.

### SUMMARY OF THE INVENTION

It is a primary object of the present invention to provide a multipurpose USB connector that is capable of connecting with a notebook or a dry battery. In use, the notebook or dry battery connected with the connector provides an electric apparatus to be charged with electric power. It is advantageous to use the present invention since the connector according to this invention provided more flexible charging options. Further, the connector according to the present is small in size, and therefore it is more convenient to use and carry.

According to the claimed invention, the multipurpose universal serial bus (USB) connector, comprising a main body having a chamber therein; a circuit unit disposed in the chamber, the circuit unit comprises a circuit board; and an output connector, an output port, and a battery connecting base that are electrically connected with the circuit board, wherein the input connector is a universal serial bus (USB) connector.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 to FIG. 3 are diagrams of the preferred embodiment according to the present invention.

FIG. 4 is a perspective view illustrating the status of this invention when in use.

FIG. 5 is a perspective view illustrating the status of this invention when in use.

FIG. 6 is a perspective view of second embodiment according to this invention.

FIG. 7 is a schematic diagram of a third embodiment according to this invention.

FIG. 8 is a schematic diagram of a fourth embodiment according to this invention.

### DETAILED DESCRIPTION OF THE PREFERRED EMBODIMENTS

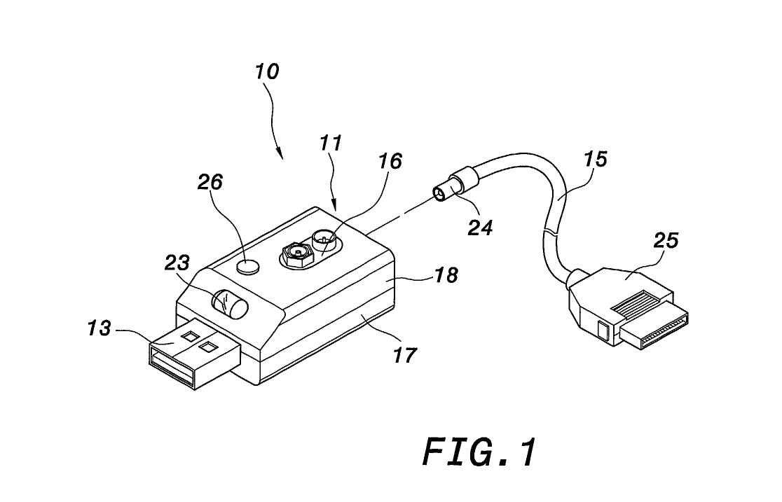

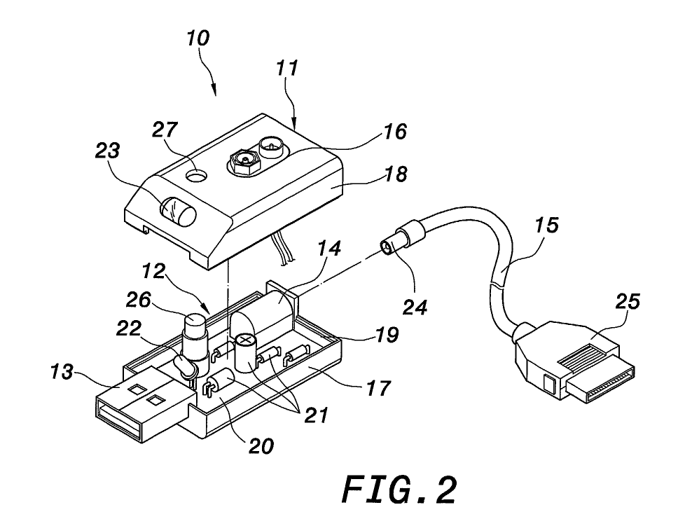

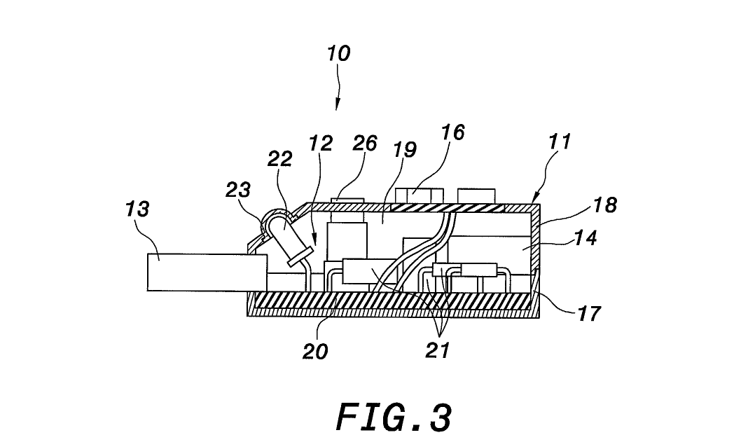

Referring to FIG. 1 to FIG. 3 of the preferred embodiment according to the present invention. This invention provides a multipurpose USB connector for charging batteries of various portable electric apparatuses. As shown in FIG. 1 to FIG. 3, connector 10 comprises a main body 11, a circuit unit 12, an input connector 13, an output port 14, an output line 15, and a battery connecting base 16. The main body 11 is a hollow casing consisting of a first half 17 and a second half 18. The first half 17 and second half 18 are assembled by means of a mechanism known in the art such as buckles, screws, or ultrasonic melting process. A chamber 19 is defined by the hollow main body 11 for accommodating the circuit unit 12.

The circuit unit 12 comprises a circuit board 20 and a plurality of electric devices 21. The circuit unit 12 is disposed in the chamber 19. A light source 22 is positioned on the circuit board 20. Preferably, the light source 22 is LED or a light bulb. The light source 22 is used for lighting, displaying, or alarming. A light cover 23 or hole is located on the main body in a position corresponding to the light source 22. A switch 26 is disposed on the circuit board 20 and an opening 27 is formed on the main body 11 corresponding to the switch 26. The switch 26 protrudes from the surface of the main body 11 by penetrating through the opening 27. The switch 26 controls the on/off states of the light source 22.

The input connector 13, output port 14, and battery connecting base 16 are fixed on the main body 11 by mechanisms known in the art such as wedges, buckles or snapping mechanism, and are electrically connected with the circuit board 20. The input connector 13 and output port 14 are exposed for connecting with a notebook or a cell phone. The battery connecting base 16 is also exposed for connecting with a dry battery. The input connector 13 is a USB connector.

The output line 15 has one plug 24 that is connected with the output port 14. In this way, the output line 15 is electrically connected with the circuit board 20. The other end of the output line 15 is a connector 25 that is used to connect a portable device such as a cell phone.

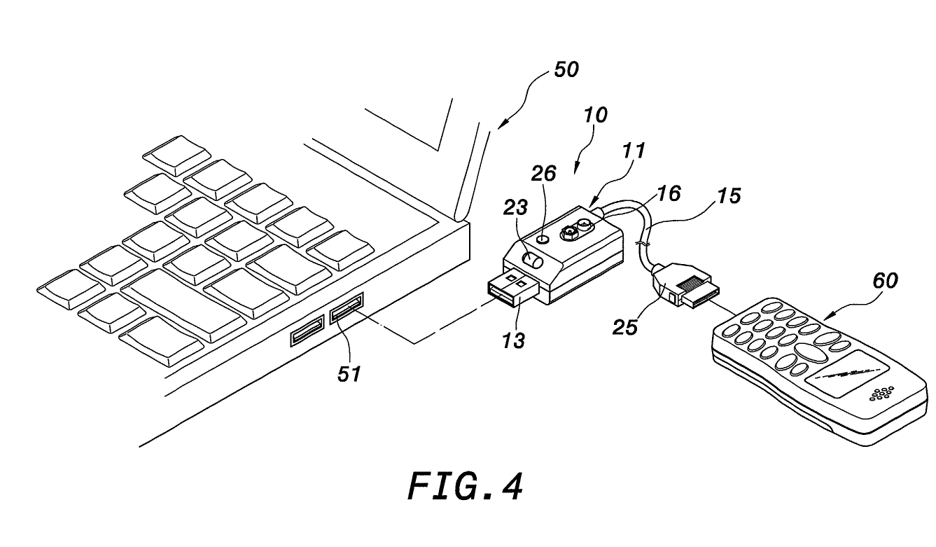

Referring to FIG. 4 of a schematic diagram exemplarily showing the use of this invention. In use, the input connector 13 is plugged in a DC output terminal 51 of the portable device 50, for example, a notebook. By this way, the input connector 13 is electrically connected with the portable device 50 that is capable of providing the connector 10 with electric power. A portable device 60 to be charged, for example, a cell phone, is plugged by the connector 25 of the output line 15 as indicated.

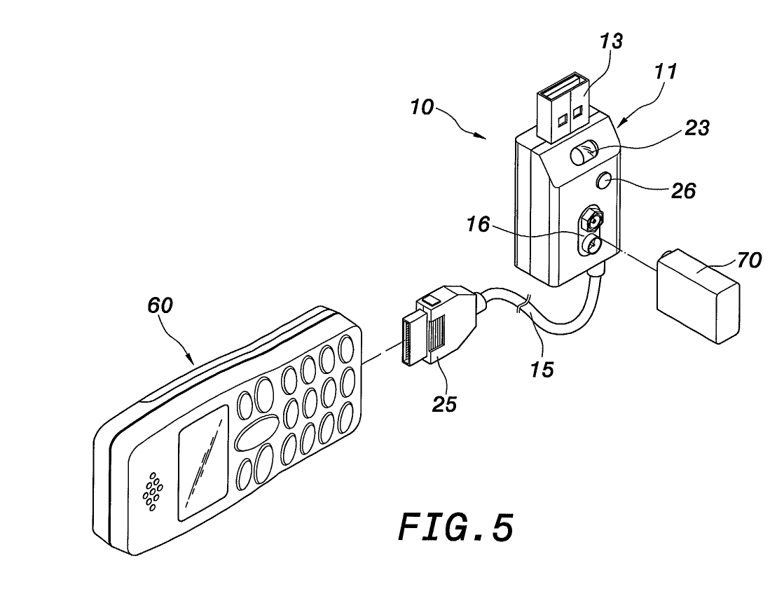

Referring to FIG. 5 of another schematic diagram exemplarily showing the use of this invention. As shown in FIG. 5, the connector 10 may be powered by a commercially available dry battery 70. In use, the dry battery 70 is electrically connected with the connecting base 16. A portable device 60 to be charged, for example, a cell phone, is plugged by the connector 25 of the output line 15 as indicated. It is convenient for a cell phone user to have this portable connector 60 that is capable of charging his or her cell phone by a dry battery.

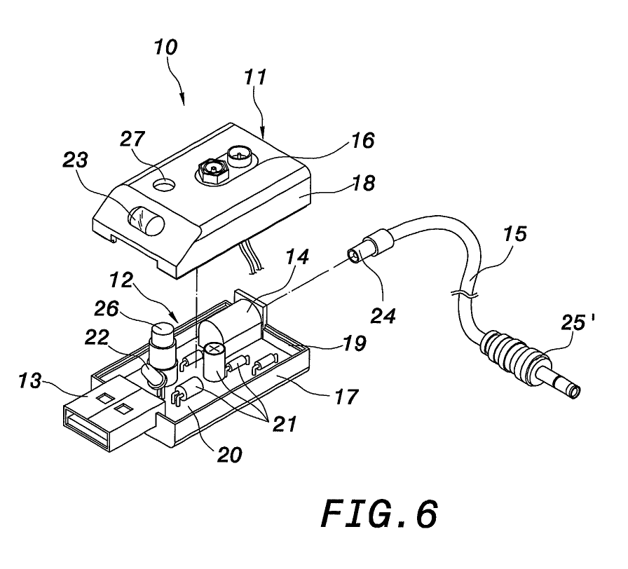

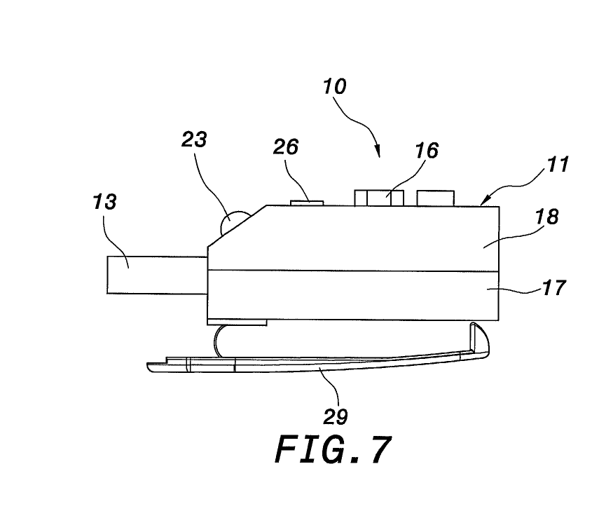

Referring to FIG. 6 of a second preferred embodiment of this invention. As shown in FIG. 6, the connector 25′ of the output line 15 may be replaced with different types of connectors. Referring to FIG. 7 of a third preferred embodiment of this invention. A clipping mechanism 29 may be formed on a wall of the main body 11. With this flexible clipping mechanism 29, a user may carry the connector 10 on his or her own belt or clothes.

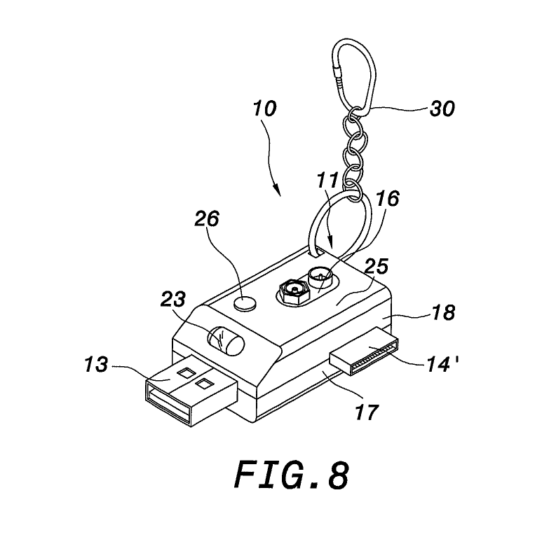

Referring to FIG. 8 of a fourth embodiment according to this invention. As shown in FIG. 8, the output port 14′ may be a typically connector. In this configuration, the cell phone to be charged can be directly plugged on the output port 14. Further, as indicated the main body 11 may combine with a key ring 30.

In short, the present provides a multipurpose connector for charging portable apparatuses such as a cell phone. The cell phone, for example, may be charged by a dry battery or a notebook through the specially designed connector 10. Moreover, the connector 10 according to this invention is small in size.

Those skilled in the art will readily observe that numerous modification and alterations of the device may be made while retaining the teachings of the invention. Accordingly, the above disclosure should be construed as limited only by the metes and bounds of the appended claims.

What is claimed is:

1 A multipurpose universal serial bus (USB) connector, comprising:
a main body having a chamber therein;
a circuit unit disposed in the chamber, the circuit unit comprises a circuit board; and
an output connector, an output port, and a battery connecting base that are electrically connected with the circuit board;
wherein the input connector is a universal serial bus (USB) connector.

2 The multipurpose USB connector of claim 1 wherein the main body consists of a first half and a second half.

3 The multipurpose USB connector of claim 1 wherein a clipping mechanism is located on a wall of the main body.

4 The multipurpose USB connector of claim 1 wherein the main body is combined with a key ring.

5 The multipurpose USB connector of claim 1 wherein the circuit board comprises a light source and the main body has a light cover or hole corresponding to the light source.

6 The multipurpose USB connector of claim 5 wherein the light source is an LED or a light bulb.

7 The multipurpose USB connector of claim 1 wherein a switch is disposed on the circuit board and an opening is formed on the main body corresponding to the switch, and wherein the switch protrudes from surface of the main body by penetrating through the opening and the switch controls the on/off states of the light source.

8 The multipurpose USB connector of claim 1 wherein the output connector, output port, and battery connecting base are fixed on the main body.

9 The multipurpose USB connector of claim 1 wherein an output line is connected with the output port, and a plug connected at a first end of the output line thereof and a connected at a second end thereof.

10 The multipurpose USB connector of claim 1 wherein the output port is a connector.
